(19) United States
(12) Patent Application Publication
(10) Pub. No.: US 2026/0071424 A1
(43) Pub. Date: Mar. 12, 2026

(54) DEVICE AND METHOD FOR PRODUCING AND SEALING A LINE FEEDTHROUGH DIRECTLY BENEATH A CEILING

(71) Applicant: Hilti Aktiengesellschaft, Schaan (LI)

(72) Inventor: Christian Förg, Buchloe (DE)

(73) Assignee: Hilti Aktiengesellschaft, Schaan (LI)

(21) Appl. No.: 19/105,160

(22) PCT Filed: Aug. 21, 2023
(86) PCT No.: PCT/EP2023/072892

§ 371 Date: Feb. 20, 2025

(30) Foreign Application Priority Data
Sep. 8, 2022 (EP) 22194634.6

(51) Int. Cl. E04B 1/94

(52) U.S. Cl. CPC E04B 1/948; E04B 1/947

(57) ABSTRACT

A device produces and seals a line feedthrough directly beneath a ceiling and has a feedthrough box to be fastened to the ceiling, with two opposite open end faces and side walls extending between them, which are open towards the ceiling and are to be closed off by the ceiling, such that the side walls in a state of the box mounted on the ceiling, together with the ceiling, form an axial passage channel which is closed in the circumferential direction. The device also has one or more support frame elements, wherein each support frame element is integrally formed or fixed on the side walls of the box on the outside thereof, and extends radially outwards in such a way that it forms an essentially planar bearing surface for supporting a wall panel, when a vertical wall is being produced or closed off around the box.

The invention relates to a device and a corresponding method for producing and sealing a line feedthrough, for example for cables or pipes. The line feedthrough should pass through a vertical wall to be produced or to be closed off, in particular a drywall, and run directly beneath a ceiling, for example in a building. It can be, in particular, a fire-resistant sealing of the line feedthrough, especially against flue gases and/or against heat transfer.

Firewalls—i.e., the restoration of the fire resistance of a building element, such as a wall or ceiling, after it has been opened and pipes and electrical lines have been installed—are usually produced in drywalls in one of the following two different ways:
In a first variant, the drywall is already present from the start. The opening is subsequently cut into the wall, for example by means of a piercing saw. Then, for example, a prefabricated fire-protection cable box—as is known in the prior art for sealing pipe or cable feedthroughs through a building wall in various embodiments—is installed. However, the lines can also be installed first, the opening can then be closed again—for example, with fire-protection plugs made of an intumescent PU foam (polyurethane)—or can be closed simply by means of a mineral wool fireblock.
In a second variant, a recess in the drywall is created when the drywall is being constructed. This procedure is typically selected when larger openings must be created. In this case, for example, a large opening is created at the same time as the construction of the wall studding—for example, by the use of suitable drywall profiles (also referred to as studs).

Moreover, prefabricated cable boxes are increasingly available, which can be cast, for example, into a concrete ceiling. Furthermore, several types of simple fire-protection cable boxes are also known, which are screwed-in directly beneath the ceiling in order to guide cables beneath the ceiling. However, a disadvantage of the latter cable boxes is that, in spite of the use of a prefabricated element, a large number of sometimes complicated work steps are necessary, such as for example attaching a seal between the ceiling and the feedthrough box; attaching a base plate; installing the lines; closing the box; installing the drywall components (studding and drywall panels); sealing the wall around the feedthrough box; sealing the lines within the box.

These and further devices for producing and/or sealing line feedthroughs in order to provide fire protection are also known, for example, from EP 3736928 A1, DE 9310405 U1, U.S. Pat. No. 7,193,153 B2, WO 06045985 A1, EP 2350512 B1, WO 14160353 A1, WO 12009211 A2, EP 2467914 B1 or WO 16058026 A1.

It is an object of the present invention to provide an alternative or improved device and a corresponding method for producing and sealing a line feedthrough, in particular for establishing an effective firewall, with which, in particular, installation can be simplified for the user and/or functionality can be improved, for example with regard to the seal and/or the robustness of the device.

This object is achieved by a device according to Claim 1 and by an associated method for producing and sealing a line feedthrough, and by a line feedthrough produced thereby, according to the independent claims. Further embodiments are specified in the dependent claims. All features and effects described herein for the device apply accordingly to the method and the line feedthrough, and vice versa.

The line feedthrough can relate in particular to electrical cables, but also to pipes or other types of lines which are to be routed through a fire compartment. With the device presented below, the line feedthrough can be produced, for example, in a wall yet to be created, in particular a drywall—but also in principle in a wall breakthrough which must be closed off. The wall can be, for example, a vertical wall in a building. It can be, in particular, a fire-resistant sealing of the line feedthrough, especially against flue gases and/or against heat transfer.

According to a first aspect, a device for producing and sealing a line feedthrough is provided directly beneath a ceiling, in particular a concrete ceiling.

For this purpose, the device comprises a feedthrough box (“box”, for short) to be fastened to the ceiling, with two mutually opposite open end faces, and side walls extending between them (i.e., in the direction of a box longitudinal axis, i.e., axially). In this case, the box and/or the side walls thereof is open towards the ceiling, and after installation is closed off by the ceiling. When the box is mounted on the ceiling, the side walls thereof thus form, together with the ceiling, an axial passage channel allowing the passage of lines and closed in the peripheral direction.

Furthermore, the device comprises one or more support frame elements (also referred to herein as mounting frames) for supporting, aligning and/or attaching one or more wall panels on the box and around the box, which wall panels are used to construct a vertical wall, in particular a drywall. For this purpose, each support frame element is integrally formed on the outside of the side walls of the box, or is otherwise fastened in a fixed or movable manner, and extends radially outwards in such a way that it forms a substantially planar bearing surface for supporting a wall panel, for example a gypsum board, when the wall is being constructed or closed around the box.

With a device prefabricated in this manner, the problems mentioned at the outset can be solved, and the above-mentioned objects can be achieved. In particular, the use of this device and the associated method makes it possible to simplify a plurality of the necessary work steps in the manufacture and sealing of a line feedthrough as compared to the above prior art, due to the embodiment described herein and the mutual arrangement of the box and the support frame elements. In addition, this device is characterized in that it also contains significantly fewer components compared to the above prior art, with comparable or even better functionality and robustness.

The line feedthrough can already be installed together with this device during the construction of a drywall. By routing the lines, in particular cables, directly beneath the ceiling, heat transfer through the lines, for example in the event of fire, to the side facing away from the fire, can be considerably reduced, because a (large) part of this amount of heat can, for example, be diverted directly to the concrete ceiling. In particular, the connection of the line feedthrough to the drywall, as described in more detail below, can also be designed such that any ceiling mobility caused by static loads—of, for example +/−0.5″—is possible without additional measures.

The box can in particular be formed as a single piece, i.e., integrally. For example, it can be produced as a single piece by mold-casting or other production methods.

According to one embodiment, the support frame element or at least one of the plurality of support frame elements is also formed as a single piece with the box. This can result in a particularly robust and/or easy to produce device. In this embodiment, however, the support frame element or at least one of the plurality of support frame elements can also be permanently and immovably fixed to the box, for example integrally formed, welded, screwed or glued, in order to achieve a similar functionality.

Alternatively or additionally thereto, at least one of the plurality of support frame elements can be axially displaceable on the box, for example in the manner of a rail. As a result, the position of the wall panel in the direction along the box can be varied or adapted. In this embodiment, the device can be flexibly adapted in particular to wall thicknesses deviating from the standard. Optionally, for this purpose, interlocking, complementary, axial rail elements can be formed on the outside of the box and on the inside of the support frame element. The displaceable support frame element can, for example, be removable as a whole from the box or be permanently connected to the box, for example by virtue of its axial displaceability on the box being limited at both end faces by mechanical stops.

The box can be designed in particular with a U-shaped radial cross-section, and for example be largely rectangular on the inside and/or outside. Other cross-sectional shapes, in particular also rounded geometries, are also possible. A rectangular geometry of the device can be not only particularly simple to manufacture and/or handle, but can also be particularly well-suited for the placing and support and/or orientation of the wall panels on the box and on the support frame elements, for example. This design can also be particularly space-saving, and in this case can be favorable for fastening the lines routed therein—all if at all possible and with the largest possible surface area of contact—directly to the ceiling, in order to enable the most effective heat transfer between warm lines and cool ceiling.

In a specific embodiment, each support frame element completely surrounds the side walls of the box in radial cross-section. In other words, in this embodiment each support frame element forms a continuous bearing surface for supporting a wall panel during the building or closing of the wall around the box (in its state mounted on the ceiling). This can simplify and improve both the building of the wall and the sealing of the line feedthrough toward the wall.

According to one embodiment, the device further comprises at least one elastically deformable, sealing closure element, which is designed and dimensioned for insertion in the passage channel (repeatedly, if necessary, with a removal between insertions) on at least one of the end faces of the box, and for tightly closing off the passage channel, whether before or after the placement of the lines. For this purpose, the elastically compressible closure element can be manufactured, for example, at least partially from an elastically deformable foam, and can have a cross-section which is approximately equal to or somewhat greater than the inner radial cross-section of the box, in order to close off the box tightly together with the lines placed therein. The closure element can serve in particular for airtight sealing of the feedthrough box with respect to the lines. It can be produced, for example, from canned foam or soft foam.

The device, in particular the box and/or the support frame elements, can be produced, for example, from a highly crosslinked rigid foam, in particular from polyurethane (PU). This PU foam can be filled, in particular for fire-protection applications, in a manner known per se with typical fire-protection additives such as, for example, expandable graphite, ammonium polyphosphate and the like.

However, the box and/or the support frame elements thereof can also be manufactured from metal and/or based on other organic or inorganic materials with application-specific desired properties with regard to porosity, weight and/or strength, and many other properties (for example as described further below). For example, gypsum or other materials based on cement are suitable for this purpose. However, it is also possible for such a cover—i.e., the device or the box thereof—to also be produced from a ceramic, for example clay. The curing can then take place, for example, by a baking process.

A device of which the box and support frame elements are made of non-intumescent materials (Le., non-foaming when exposed to heat) can be used directly for feedthroughs which are designed, for example, solely for insulating sound and air or other gases and odors, and do not have to be fire-resistant. No particular class of materials is absolutely necessary in such applications in order to seal the line.

However, if such a device (in particular made of inorganic materials) is used for fire-protection feedthroughs, it must be ensured that the line seal is resistant enough to achieve the desired fire-resistance duration. As a line seal with a fire-protection function, it is possible here, for example, to use intumescent (i.e., foaming under the influence of heat) foams or mineral wool in combination with a fire-protection sealing compound in a known manner.

When an intumescent base material is used for the box, this can close off the opening in the center (i.e., the passage channel) by the heat-induced foaming of the base material itself in the event of a fire. The rest of the seal, provided for example by at least one closure element as described above, can then largely serve to seal against smoke gas, so that a normally flammable foam is also sufficient for this purpose.

With regard to further material properties for the base material of the box, it is possible, in particular, to use a material which has a small proportion of pores, and thus a material volume density of, for example, between 0.3 and 1—and up to 2.7 for inorganic materials. In the case of a highly crosslinked polyurethane (PU), this is ensured, for example, by the fact that the material is somewhat foamed. In the case of inorganic materials, the use of hollow spheres is a possibility, in order to produce pores with a desired size. Of course, this desired porosity can also be ensured by air or gas inclusions during production.

The aforementioned porosity can be helpful in particular for attaching the box or the support frame elements by means of screws to the ceiling and/or to a drywall profile. As an alternative, for example, pre-drilled through-holes in the box or the support frame elements would be required for a screw attachment. This is not necessary when using a suitable porous base material.

According to one embodiment, the box and/or each support frame element is therefore produced from a porous base material-except for any linings (for example, fire-protection and/or other protective layers). In this embodiment, the porous base material can in particular be an inorganic material having a volume density of at most about 3, in particular between about 0.3 and about 2.7, or an organic material having a volume density of at most about 2, in particular between about 0.3 and about 1. The aforementioned porosity of the base material or the stated volume density can be produced in particular by hollow spheres uniformly distributed in the material.

As already mentioned, the device can in particular meet predetermined fire-protection requirements. For this purpose, for example, at least one of its components can comprise or consist of fire-protection additives, intumescent materials, and/or refractory materials. Alternatively or additionally, for example, at least one intumescent element provided specifically for this purpose can be arranged in the passage channel and/or on at least one support frame element, and can be designed to seal the passage channel and/or the line feedthrough with respect to the wall in the event of a fire, in order to prevent fire propagation. This can be realized, for example, in the form of an at least partial lining of the side walls of the box and/or of the support frame elements, on the inner and/or outer side thereof, with intumescent strips or tapes.

With regard to fire protection, different variants are also possible for the choice of material of the at least one elastically deformable closure element mentioned herein, depending on which sealing effect is to be achieved and which materials were used in the box. If, for example, the box is manufactured from an intumescent material, the required fire resistance can be achieved as far as possible by this mode of operation. There is then a wide choice of material for the closure element. If, on the other hand, the box is produced only on the basis of inorganic materials, the required fire-resistance duration can be achieved by the choice of the sealing material of the closure element. Materials suitable for this could, for example, be an intumescent foam or mineral wool with a flame-retardant coating.

For the arrangement of the closure elements in the passage channel, an installation depth of approximately 10-50 mm per closure element at each end face of the box (i.e., a sealing of the passage channel at both ends) has proven particularly suitable in particular with regard to the fire-protection effect.

As regards the choice of material for the support frame elements (also referred to herein as mounting frames), such a frame is the most cost-effective to produce, for example, from metal. However, metal itself has only very low insulating properties. In this case, a required insulating effect can be ensured, for example, by a thin intumescent strip which is glued onto the mounting frame. In the event of a fire, a gap between the box and the respective wall panels (gypsum board) can be completely closed by this intumescent layer. For the insulating effect of such an intumescent layer, it can be ensured, for example, that, in particular, the required maximum temperature on the side facing away from the fire of, for example, a maximum of 180° C. can also be maintained in this spatial region.

For a removable support frame element or a support frame element which can move on the box, the use of an (in particular U-shaped) sheet metal frame is also possible—the same coated only on the inside, i.e., towards the box, and/or on its bearing surface, with an intumescent material. Alternatively, a U-shaped metal sheet without a coating and with only an intumescent foam piece for closing off the box with respect to the room and/or to the respective wall panel is also possible.

In particular, the device can further comprise at least one wall-producing ceiling profile element (also referred to herein as a drywall profile, ceiling profile, drywall ceiling profile, or metal profile of the (drywall) studding), which is designed for attachment beneath the ceiling and for fastening to the respective support frame elements in order to expand their bearing surface for a wall panel, for example a gypsum board, when the vertical wall is being constructed or closed off around the box. Such a wall-producing ceiling profile element can in particular be made of metal. For example, it can be designed to plug precisely onto one or more support frame elements of the device. On the other hand, the device described herein can be provided without such ceiling profile elements, and can be used with ceiling profile elements standardly available, for which in turn the support frame elements of the device are designed and dimensioned for a precise fit.

According to a further aspect, a method is provided for producing and sealing a line feedthrough directly beneath a ceiling, using a device presented herein. The method can comprise in particular the following steps:

The feedthrough box is attached to the ceiling so that the side walls of the box form an axial passage channel together with the ceiling, which is closed in the peripheral direction, allowing the passage of line through a vertical wall to be erected beneath the ceiling. Optionally, it is possible to align and attach at least one above-mentioned wall-producing ceiling profile element to the one or more support frame elements in order to extend the bearing surface formed by the respective support frame elements for supporting a wall panel in the direction along the ceiling.

Before, thereafter, or at a different point in time, one or more lines can be laid in the passage channel formed by the box. In this case, the lines can be fastened to the ceiling such that they have the greatest possible contact with the ceiling. This can contribute in particular to the dissipation of heat from the lines to the ceiling, for cooling the lines in the event of a fire.

If the device comprises one or more of the closure elements mentioned herein, the passage channel formed by the box together with the lines optionally laid therein can be sealed at at least one end face with a closure element. For this purpose, the closure element designed and dimensioned specifically for this purpose is, for example, simply inserted into the passage channel, as described in more detail above.

A vertical wall can be constructed before or thereafter around the box by the application and alignment of at least one wall panel, in particular of a gypsum board, with its wall panel surface directly on the bearing surface of the respective support frame elements, and optionally also on the at least one wall-producing ceiling profile element fastened thereto. The steps of laying the lines and sealing the passage channel with closure elements can in principle be carried out before or after any other step of the method, in any sequence, and in particular even after the production of the wall, and/or repeated several times subsequently.

According to one embodiment, when the wall is being constructed, the respective wall panels are placed on the associated support frame elements and aligned in such a way that a predetermined, in particular vertical, spacing—which is measured along the support frame element—remains between the box and an edge of the wall panel facing the box. In this way, a corresponding mobility of the box with respect to the wall panel, for example in the case of static loads on the ceiling, can be made possible without further additional measures being required. As mentioned further above, the mobility can be +/−0.5″, for example.

According to a further aspect, a line feedthrough is provided which is created directly beneath a ceiling in an adjoining vertical wall by a method provided herein. As mentioned, in this case a predetermined, in particular vertical, spacing which is measured along the support frame element can remain between the box and the edge of the respective wall panels of the wall facing the box, which spacing allows freedom of movement of the wall panel by, for example, approximately +/−0.5″.

The above aspects, embodiments and specific configurations of the invention are explained in more detail below with reference to the exemplary embodiments shown in the drawings. The drawings are schematic. Said drawings may be, but do not have to be, understood as true to scale. In the drawings:

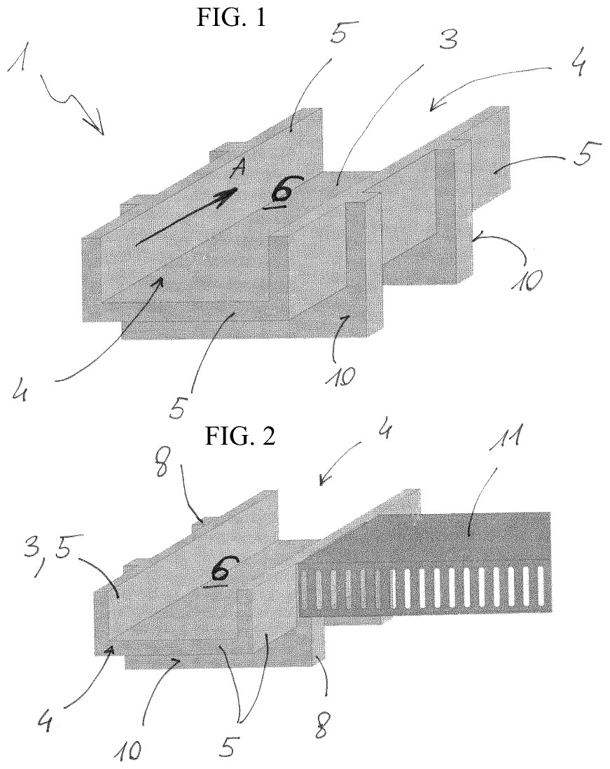

FIG. 1 is a perspective view of a device according to one embodiment of the invention for producing and sealing a line feedthrough, having two support frame elements formed as a single piece with a feedthrough box;

FIG. 2 is the same perspective view of the device of FIG. 1, with a wall-producing ceiling profile element fastened to the support frame elements;

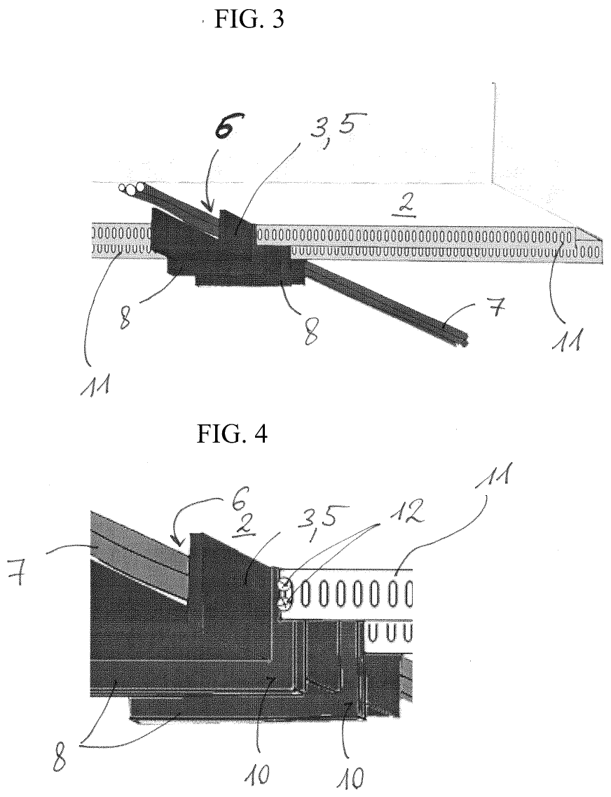

FIG. 3 shows a further perspective view of the device of FIG. 2 in its state mounted on the ceiling, and with lines laid;

FIG. 4 shows an enlarged detail of FIG. 3 with a view of the fastening of the ceiling profile element to the support frame elements;

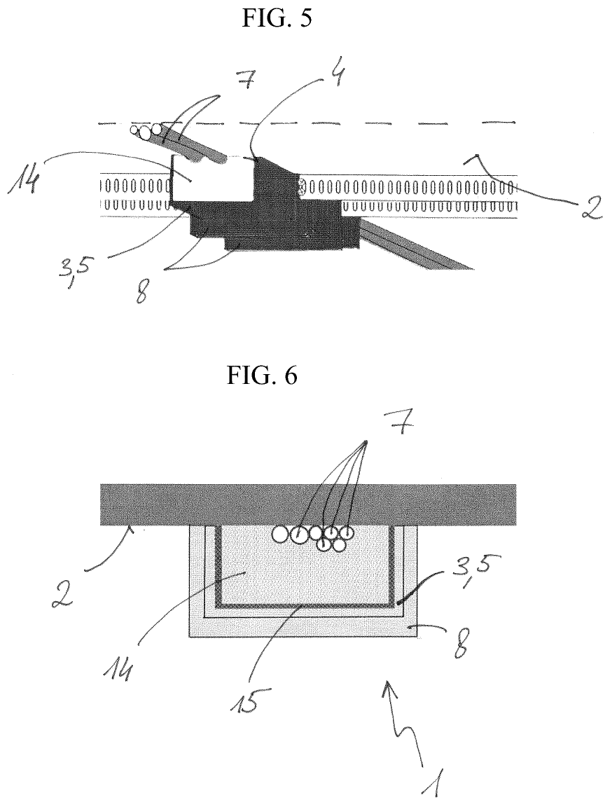

FIG. 5 shows a further perspective view of the device of FIG. 3 with a passage channel sealed by a closure element;

FIG. 6 shows a radial cross-section of a device according to one embodiment of the invention, with an intumescent material layer as an inner lining of the box; and

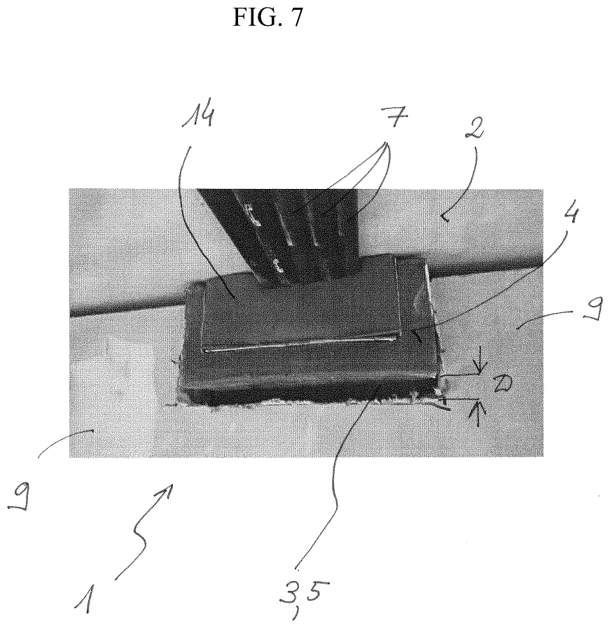

FIG. 7 shows a perspective view of a line feedthrough which has been produced and sealed using a method according to an embodiment of the invention.

All of the various embodiments, variants and specific design features of the device for producing and sealing a line feedthrough, the associated method and the line feedthroughs produced therewith according to the above aspects of the invention, as mentioned above in the description and in the following claims, can be implemented in the examples shown in FIG. 1 to 7. They are therefore not all repeated again below. The same applies correspondingly to the definitions of terms and effects already specified above in relation to individual features which are shown in FIGS. 1-7. To avoid repetition, reference is therefore made to the more detailed description of the invention further above and in the claims.

FIG. 1 shows a perspective view of a device 1 according to an embodiment of the invention for producing and sealing a line feedthrough directly beneath a room ceiling 2 (see FIGS. 3-7) in a wall to be constructed only later (see FIG. 7)—in this example, a drywall.

For this purpose, the device 1 comprises a feedthrough box 3 (box 3) to be fastened to the ceiling 2, with two opposite open end faces 4, and with side walls 5 extending between them in the direction of the box longitudinal axis A. In this case, the box 3 is open towards the ceiling 2 and is closed off by the ceiling 2 during installation. In a state of the box 3 mounted on the ceiling 2 (see FIGS. 3-7), the side walls 5 thereof thus form, together with the ceiling 2, an axial passage channel 6, which is closed in the circumferential direction, for the passage of lines 7.

Furthermore, the device 1 in this example comprises two support frame elements 8 (also referred to herein as mounting frames) for supporting, aligning and/or attaching one or more wall panels 9 with which the drywall will be constructed (in this example gypsum boards, see FIG. 7) on the box 3 and around the box 3. For this purpose, in this example, each support frame element 8 is integrally formed on the outside of the side walls 5 of the box 3 and extends radially outwards in such a way that it forms a substantially planar bearing surface 10 for supporting the wall panel 9 around the box 3.

In this example, both support frame elements 8 are formed in one piece, and thus also immovably with the feedthrough box 3. Alternatively or additionally, a support frame element 8 can be axially displaceable on the box 3 (not shown), to allow for varying or adapting the position of the wall panel 9 in the direction along the box 3.

In this example, in radial cross-section, the box 3 and both support frame elements 8 are U-shaped, and are rectangular inside and/or on the outside, purely by way of example. For example, porous material can be used as a base material for the production thereof in a manner described in detail further above.

FIG. 2 shows in the same perspective view as FIG. 1 the device 1 with a wall-producing ceiling profile element 11 (also referred to herein as a drywall profile, ceiling profile, drywall ceiling profile, or metal profile of the (drywall) framing) fastened to the support frame elements 8. In this example, the ceiling profile element 11 is a strip-shaped element made of metal, which can be aligned precisely with respect to the two support frame elements 8, and pre-fastened to them. Subsequently, it can be fastened to the support frame elements 8, for example, by drywall screws 12 (see FIG. 4).

FIG. 3 shows a further perspective view of the device 1 of FIG. 2 in its state mounted on the ceiling 2 and with laid lines 7—in this example, several cables. FIG. 4 shows an enlarged detail of FIG. 3 highlighting the fastening of the ceiling profile element 11 to the support frame elements 8 by screws 12. As a result of the arrangement of the lines 7 (cables in this case) shown in the figures without a spacing, i.e., directly below the ceiling 2, it has been found to be very advantageous in a representative fire test that the lines 7 can dissipate heat directly into the “cold” concrete ceiling 2 on the side facing away from the fire.

FIG. 5 shows a further perspective view of the device 1 of FIG. 3, wherein its passage channel 6 has been sealed (i.e., closed off tightly) with an elastically deformable closure element 14. In this example, the closure element 14 is a foam element which is dimensioned and elastically compressible for sealing the passage channel. As illustrated in FIG. 5, the closure element 14 is designed to have the elasticity to enable a simple shape adaptation to the lines 7 in order to seal the box 3 adequately for different numbers and types of lines 7 (and in particular, also in the case where there are no lines).

FIG. 6 shows a radial cross-section of a device 1 according to an embodiment of the Invention, which can in particular be the device of FIGS. 1-5. In this example, the box 3 is sealed by a closure element 14 and additionally lined on the inside with an intumescent material layer/coating 15, such that the intumescent layer 15 can additionally close the line feedthrough in the event of a fire by expansion into the passage channel 6. This variant can be used, for example, if the box 3 itself is produced based on inorganic materials. Otherwise, as mentioned further above, the base material of the box 3 and/or of the support frame elements 8 can also contain or consist of an intumescent material, so that no additional lining or coating is necessary to fulfill fire-protection requirements.

FIG. 7 is a perspective view of a finished line feedthrough which has been produced and sealed using a method according to an embodiment of the invention. The line feedthrough shown has been produced using a device 1 according to FIGS. 1-6 as described further above and in the claims. The above-mentioned installation panels 9 (for example, gypsum boards) lie flat on the mounting frame (i.e., on the bearing surfaces 10 of the support frame elements 8, which are concealed in FIG. 7), so that a sliding connection is produced here. In addition, in this example, the installation panels 9 are installed at a predetermined vertical distance D from the box 3 such that in the event of a static load on the ceiling 2 they can flex unhindered. As a result, for example, a mobility of, for example, +/−0.5″ can be possible without additional measures.

As already mentioned, the device and method presented herein for producing and sealing a line feedthrough can in particular enable a fast installation, wherein no further sealing materials are necessary. The installation of the feedthrough and, if necessary, also of the lines is possible at a very early stage of construction of the wall. The installation of the lines and the feedthrough is also possible in the case of a wall which is not yet finished. A sliding connection of the device to the gypsum board makes possible a movement between ceiling and drywall without an additional measure. The line feedthrough can be produced cost-effectively, complying with requirements for impermeability and, if necessary, also fire-protection requirements. The fire-protection function can be integrated into the U-shaped feedthrough box. The airtight seal can also be achieved by standard materials, such as, for example, construction foam. Alternatively or additionally, however, the fire-protection function can also be located in the sealing closure elements. The box 3 and/or the support frame elements 8 thereof can in particular be thermally resistant to temperatures of more than 1000° C.

1. A device for producing and sealing a line feedthrough directly beneath a room ceiling, the device comprising:
a feedthrough box to be fastened to the room ceiling, with two opposite open end faces and side walls extending between them, which are open towards the room ceiling and are to be closed off by the room ceiling, such that the side walls in a state of the feedthrough box mounted on the room ceiling form together with the room ceiling an axial passage channel, which is closed in a circumferential direction, for routing lines through the same; and
one or more support frame elements, wherein each of the one or more support frame element is integrally formed or fixed on the side walls of the feedthrough box on an outside thereof, and extends radially outwards in such a way that it forms a substantially planar bearing surface for supporting a wall panel, when a vertical wall is produced or closed off around the feedthrough box.

2. The device according to claim 1, wherein
the feedthrough box is formed as a single piece.

3. The device according to claim 1 wherein
the one or more support frame element is integrally formed with the feedthrough box, or is permanently and immovably fixed thereto in another way.

4. The device according to claim 1, wherein
the one or more support frame element is axially displaceable on the feedthrough box.

5. The device according to claim 1, wherein
the feedthrough box has a U-shaped radial cross-section.

6. The device according to claim 1, wherein
each of the one or more support frame elements completely surrounds the side walls of the feedthrough box in a radial cross-section.

7. The device according to claim 1, further comprising:
at least one elastically deformable sealing closure element which is designed and dimensioned for repeated insertion into the axial passage channel at at least one of the two opposite end faces of the feedthrough box, optionally after the routing lines have been laid, and for tightly closing off the axial passage channel, optionally with the routing lines laid therein.

8. The device according to claim 1, wherein
the feedthrough box and/or each of the one or more support frame elements is produced from a porous base material, except for any linings.

9. The device according to claim 8, wherein the porous base material is
an inorganic material having a volume density of at most about 3; or
an organic material having a volume density of at most about 2.

10. The device according to claim 8, wherein
a porosity of the porous base material is produced by hollow spheres distributed essentially uniformly in the porous base material.

11. The device according to claim 1, which meets predetermined fire-protection requirements, in that
at least one of its components comprises or consists of fire-protection additives, intumescent materials, and/or refractory materials; and/or
at least one intumescent element is arranged in the axial passage channel and/or on at least one of the one or more support frame elements, and is designed to seal the axial passage channel and/or a wall opening in an event of a fire, in order to prevent fire propagation.

12. The device according to claim 1, further comprising:
at least one wall-producing ceiling profile element, which is designed for attachment beneath the room ceiling and for fastening to the respective one or more support frame elements in order to expand their substantially planar bearing surface for a wall panel, when a vertical wall is produced or closed off around the feedthrough box.

13. A method for producing and sealing a line feedthrough directly beneath a room ceiling, employing the device according to claim 1, the method comprising:
fastening the feedthrough box to the room ceiling, such that the side walls of the feedthrough box form an axial passage channel together with the room ceiling, which is closed in a peripheral direction, for passage of routing lines through a vertical wall to be constructed beneath the room ceiling;
optionally aligning and attaching at least one wall-producing ceiling profile element on the one or more support frame elements in order to extend the bearing surface formed by the respective one or more support frame elements, for supporting a wall panel;
optionally laying one or more routing lines in the axial passage channel;
optionally sealing the axial passage channel, together with the routing lines optionally laid therein, with a closure element on at least one end face;
producing a vertical wall around the feedthrough box by placing and aligning at least one wall panel with its wall panel surface directly on the bearing surface of the respective one or more support frame elements, and optionally also on the at least one wall-producing ceiling profile element fastened thereto.

14. The method according to claim 13, wherein
when the vertical wall is being constructed, each of the at least one wall panels is placed and aligned on the associated one or more support frame elements in such a way that a predetermined spacing (D), which is measured along the one or more support frame element, remains between the feedthrough box and an edge of the wall panel facing the feedthrough box.

15. A line feedthrough which is produced directly beneath a room ceiling in an adjoining vertical wall by a method according to claim 13, wherein
a predetermined spacing (D) which is measured along the one or more support frame element remains between the feedthrough box and the edges of the respective wall panels of the wall facing the feedthrough box, which spacing allows a freedom of movement of the wall panel relative to the room ceiling.
